(19) United States
(12) Patent Application Publication
(10) Pub. No.: US 2010/0001645 A1
(43) Pub. Date: Jan. 7, 2010

(54) SEAT OPERATION UNIT

(75) Inventor: Marco Krämer, Wolpertshausen (DE)

Correspondence Address: POSZ LAW GROUP, PLC, 12040 SOUTH LAKES DRIVE, SUITE 101, RESTON, VA, 20191, US

(73) Assignee: RECARO Aircraft Seating GmbH & Co., KG, Schwäbisch Hall (DE)

(21) Appl. No.: 12/449,249

(22) PCT Filed: Jan. 12, 2008
(86) PCT No.: PCT/EP2008/000213

§ 371 Date: Jul. 30, 2009

(30) Foreign Application Priority Data
Feb. 7, 2007 (DE) 10 2007 006 033.7

(51) Int. Cl. B60Q 1/14

(52) U.S. Cl. 315/77; 362/471

(57) ABSTRACT

The invention relates to a seat control unit, in particular an aircraft seat control unit, having at least one light unit (10). The seat control unit has an adjusting unit (12), which electronically adjusts the light intensity and/or light color of the light unit (10).

### BACKGROUND

The invention is based on a seat operation unit.

Seat operation units with light-emitting units are already known.

### SUMMARY

The invention is based on a seat operation unit, particularly an aircraft seat operation unit, having at least one light-emitting unit.

It is proposed that the seat operation unit comprise an adjusting unit which is intended to electronically adjust the light intensity and/or light color of the light-emitting unit. In this context, a “seat operation unit” is intended to be understood to mean particularly a unit which a person in a seat can use to make inputs, such as particularly adjustments. In this case, the seat operation unit may have just one input unit associated with a seat apparatus or else a plurality of input units associated with one and/or else more seat apparatuses.

An “adjusting unit which can be used to electronically adjust a light intensity and/or a light color” is intended to be understood to mean particularly a unit which comprises an electronics unit and/or preferably a processor unit and which can be used to produce various, in particular constant, light intensities, particularly not equal to zero and/or light colors particularly without interchanging light-emitting means. In addition, “intended” is intended to be understood to mean particularly specially equipped, designed and/or programmed.

An appropriate embodiment allows a high level of flexibility to be achieved, specifically both for a passenger and/or also particularly for an interior designer, such as particularly an aircraft cabin designer. In this case, the adjusting unit is preferably intended to allow at least individual adjustments to be made only by a member of specialist personnel, so that individual, undesirable alterations by a passenger can be prevented. In particular, the seat operation unit can be matched, with little complexity, to different constraints and particularly to different customer requirements, such as particularly airlines. When used over a large area, it is advantageously possible to take account of design aspects, specifically particularly when the adjusting unit can be used to adjust a plurality of light-emitting units, associated with a plurality of seat apparatuses, centrally. In addition, it is a simple matter to compensate for instances of dimming caused by aging.

Preferably, the adjusting unit is intended to be at least partially integrated into a seat apparatus, which allows advantageous simple actuation to be achieved. In this case, “integrated” is intended to be understood particularly to mean that at least a portion of the adjusting unit forms a mounting unit together with a seat apparatus, such as particularly with a single seat apparatus in an aircraft. Advantageously, at least a portion of the adjusting unit is also arranged centrally, so that a plurality of seat operation units, particularly also as plurality of seat rows, can advantageously be actuated together.

In a further embodiment of the invention, it is proposed that the processor unit be at least partially in integral form with a seat control unit, which allows components, weight, mounting complexity and/or costs to be saved. In this case, a “processor unit” is intended to be understood particularly to mean a unit which comprises a processor or a computation unit and a memory unit with an operating program stored therein.

In addition, it is proposed that the seat operation unit have a processor unit which is intended to adjust at least one adjusting operation at least semi-automatically on the basis of at least one parameter, which allows particularly convenience to be increased. By way of example, present room illumination can be taken as a basis for automatically adjusting the color and/or the light intensity of the seat operation unit.

The light-emitting unit may have various light-emitting means which appear appropriate to a person skilled in the art. Particularly advantageously, however, the light-emitting unit has at least one light-emitting diode and/or a light-emitting foil which can be integrated in a particularly space-saving manner and also can be advantageously actuated in order to obtain different light intensities and/or light colors. In this connection, a light-emitting foil is intended to be understood particularly to mean a foil of multilayer design, specifically particularly with a layer which is formed by a rear electrode, a layer which is formed by an insulator, a layer which is formed by a light-emitting material and a layer which is formed by a front electrode. In this case, the light-emitting unit may have light-emitting diodes in one color, in different colors and/or also light-emitting diodes which emit different light colors depending on an applied voltage and/or frequency.

If the light-emitting unit has light-emitting means which are intended to emit light in different colors, adjustment can be achieved by means of a simple design, specifically particularly if the adjusting unit is intended to produce different light colors by mixing, particularly differentiated mixing, of light colors, wherein at least one output color is produced by mixing light from at least two light sources in different colors and/or preferably at least emitted light in a particular color from at least one light source is used for at least two output colors.

### BRIEF DESCRIPTION OF THE DRAWINGS

Further advantages can be found in the description of the drawing which follows. The drawing shows an exemplary embodiment of the invention. The drawing, the description and the claims contain numerous features in combination. A person skilled in the art will expediently also consider the features individually and combine them to form appropriate further combinations.

FIG. 1 is a side view of a seat apparatus, and

FIG. 2 is a schematic illustration of a seat operation unit and a seat control unit in the seat apparatus of FIG. 1.

### DETAILED DESCRIPTION OF THE PREFERRED EMBODIMENTS

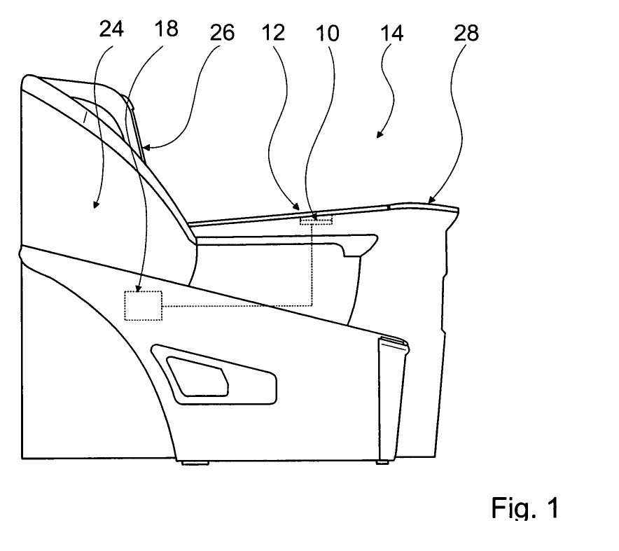

FIG. 1 shows a seat apparatus 14 in an aircraft or an aircraft seat apparatus in a side view with a seat housing 24, within which a backrest 26 and a seat base—not shown in more detail—are arranged. The seat apparatus comprises a console 28 and a seat operation unit, integrated therein, with a light-emitting unit 10. The seat operation unit can be used by a passenger to adjust the seat base and the backrest 26 via a seat control unit 18 in the seat apparatus.

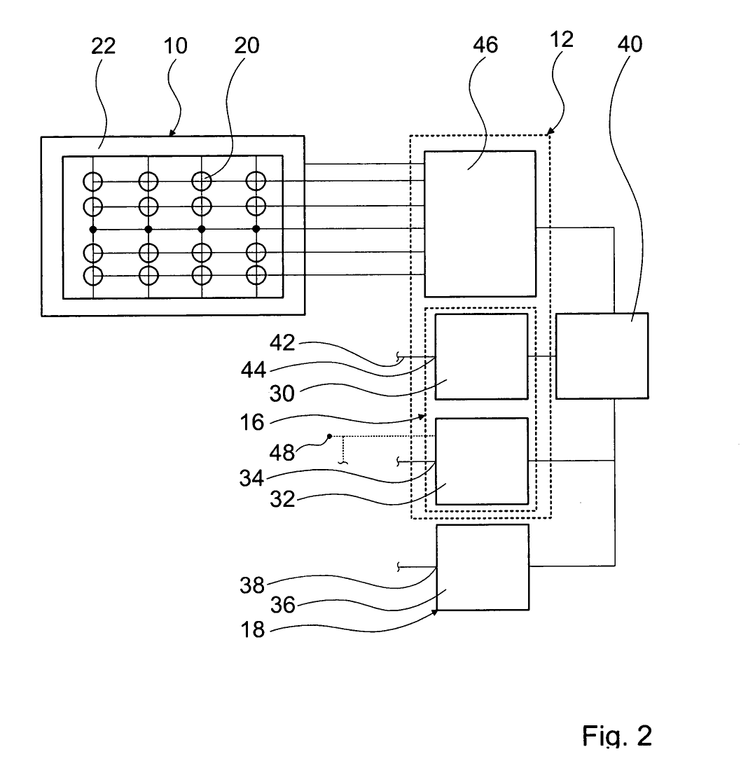

The seat operation unit has an adjusting unit 12 which is intended to adjust the light intensity and light color of the light-emitting unit 10 electronically, i.e. particularly without interchanging light-emitting means (FIG. 2). In this case, the adjusting unit 12 is intended to be operated exclusively by a member of specialist personnel, i.e. not by a passenger.

The adjusting unit 12 comprises a processor unit 16 which is in partially integrated form with the seat control unit 18, specifically the processor unit 16 and the seat control unit 18 have a common computation unit 30 or a common processor. In addition, the seat control unit 18 and the adjusting unit 12 are supplied with direct current by means of a common power supply unit 40.

In addition, the adjusting unit 12 comprises a memory unit 32 which stores an operating program. The memory unit 32 has an interface 34 which can be used to interchange an operating program locally on the seat apparatus 14, specifically by installing a new operating program and/or by deactivating a selected operating program and activating an operating program which is already stored in the memory unit 32. As an alternative and/or in addition, an operating program could also be arranged for a plurality of seat apparatuses centrally in a memory unit and/or an interface 48 could be provided which can be used to access a plurality of memory units, so that the operating program can be changed centrally for a plurality of seat apparatuses 14, particularly also for a plurality of seat rows, as indicated in FIG. 2. The seat control unit 18 comprise a memory unit 36 with an operating program stored therein which can be interchanged centrally via an interface 38, i.e. the operating program can be interchanged centrally simultaneously particularly for a plurality of seat apparatuses 14.

In addition, the processor unit 16 is intended to perform an adjusting operation on the basis of present room illumination. For this purpose, the processor unit 16 is supplied with data about the present room illumination via a data bus 42 and via an interface 44.

The light-emitting unit 10 has a light-emitting foil 22 and a plurality of light-emitting diodes 20 which are intended to emit light in different colors. The processor unit 16 is used to actuate the light-emitting foil 22 and the light-emitting diodes 20 via an electronics control converter 46.

The light-emitting foil 22 is intended to emit light of different intensity and in different colors, whereas the processor unit 16 is intended to use the light-emitting diodes 20 to produce different light colors by mixing light colors.

1-11. (canceled)

12. An aircraft seat operation unit, having at least one light-emitting unit, wherein the seat operation unit includes an adjusting unit, which electronically adjusts the light intensity or light color of the light-emitting unit.

13. The seat operation unit as claimed in claim 12, wherein the adjusting unit is at least partially integrated into a seat apparatus.

14. The seat operation unit as claimed in claim 12, wherein the adjusting unit comprises a processor unit.

15. The seat operation unit as claimed in claim 14, wherein the processor unit is at least partially formed integrally with a seat control unit.

16. The seat operation unit as claimed in claim 12, further comprising a processor unit, which adjusts at least one adjusting operation at least semi-automatically on the basis of at least one parameter.

17. The seat operation unit as claimed in claim 12, wherein the light-emitting unit has at least one light-emitting diode.

18. The seat operation unit as claimed in claim 12, wherein the light-emitting unit has at least one light-emitting foil.

19. The seat operation unit as claimed in claim 12, wherein the light-emitting unit has a light-emitting device that emits light in different colors.

20. The seat operation unit as claimed in claim 19, wherein the adjusting unit produces different light colors by mixing light colors.

21. The seat operation unit as claimed in claim 12, wherein the seat operation unit is part of an aircraft seat apparatus.

22. The seat operation unit according to claim 12, wherein the seat operation unit electronically adjusts the light intensity and light color of the light-emitting unit.

23. A method of operating a seat operation unit having at least one light-emitting unit, wherein the seat operation unit includes an adjusting unit, which electronically adjusts the light intensity or light color of the light-emitting unit, and wherein the method comprises adjusting the light intensity or light color of the light-emitting unit electronically.

24. The method according to claim 23, wherein the adjusting includes adjusting the light intensity and light color of the light-emitting unit electronically.
